(19) United States
(12) Patent Application Publication
(10) Pub. No.: US 2026/0316917 A1
(43) Pub. Date: Oct. 15, 2026

(54) IMPULSE PROPULSION

(71) Applicant: Kongsberg Maritime AS, Kongsberg (NO)

(72) Inventor: Rune Garen, Eiksund (NO)

(21) Appl. No.: 19/485,855

(22) PCT Filed: May 22, 2024
(86) PCT No.: PCT/EP2024/064012

§ 371 Date: Nov. 19, 2025

(30) Foreign Application Priority Data
May 25, 2023 (EP) 23175466.4

(51) Int. Cl. B63H 21/21; B63H 1/20; B63H 21/17; G05D 1/611; G05D 109/30

(52) U.S. Cl. CPC B63H 21/21; B63H 1/20; B63H 21/17; G05D 1/611; B63H 2021/216; G05D 2109/34

(57) ABSTRACT

The invention relates to providing impulse propulsion to a vessel. In preferred embodiments, impulse propulsion is provided by increasing a rotational speed of a propeller in real-time.

### FIELD OF THE INVENTION

The invention relates to providing impulse propulsion to a vessel. In preferred embodiments, impulse propulsion is provided by increasing a rotational speed of a propeller in real-time.

### BACKGROUND OF THE INVENTION

A marine vessel is typically equipped with one or more propellers to be provide propulsion of the vessel. While propulsion of vessels has been provided for decades by propellers, the propellers have developed into thrusters, such as rim drive azimuth thrusters and rim drive tunnel thrusters which have proven to be more versatile than traditional propeller configurations. The versatility is in particular pronounced in dynamic position and/or low speed manoeuvring of a vessel.

Operation of propellers and in particular thrusters during dynamic positioning and/or low speed manoeuvring has been focussed towards the goal of achieving precision in dynamic positioning and/or low speed manoeuvring and only little or even no attention has been paid to the power consumption during such operation.

Such lack of attention to power consumption may arise from the general teaching that altering the rotational speed of a propeller must be carried out in a sufficiently slow manner so as to allow for the flow of water through the propeller to reach fluid dynamic quasi-stable conditions during an increase or decrease of rotational speed of the propeller.

Thus, while present operation of propellers achieves a precise dynamic positioning and/or precise low speed manoeuvring of a marine vessel, the power consumption during such operating is typically considerably.

Hence, an improved method of operating propellers and in particular thruster would be advantageous, and in particular a more energy efficient operation would be advantageous.

### OBJECT OF THE INVENTION

It is an object of the present invention to provide an improved method of operating propellers and in particular thruster, especially but no necessarily limited to during dynamic positioning and/or low speed operation.

It is a further object of the present invention to provide a more energy efficient method of operating propellers and in particular thruster, especially but no necessarily limited to during dynamic positioning and/or low speed operation.

It is a further object of the present invention to provide an alternative to the prior art.

### SUMMARY OF THE INVENTION

Thus, the above described object and several other objects are intended to be obtained in a first aspect of the invention by providing a method of providing impulse propulsion to a vessel by a propulsion system.

The propulsion system preferably comprising
a propulsion device having a rotatable propeller and producing a thrust having a magnitude depending on a rotational speed of said propeller;
an electrical motor coupled to said propeller to provide said rotational speed,
a control unit, such as an propulsion control system, configured to receive a thrust request representing a thrust to be requested from the propulsion device and configured to control said electrical motor to rotate said propeller at a rotational speed corresponding to the thrust request.

The method preferably comprising upon receipt of a thrust request by said control unit, said control unit controls said electrical motor to increase or decrease in real-time the rotational speed of said propeller to a rotational speed corresponding to the thrust request.

Terms used herein are used in a manner being ordinary to a skilled person. Some of the used terms are elucidated here below:

Impulse propulsion refers to that the propulsion device supply impulse onto the water. The impulse supplied to the water is provided by thrust force provided by the propulsion device onto the water, thereby providing a reaction force on the propulsion device for moving the vessel. Impulse propulsion is inter alia characterized in the rotational speed of the propeller assisting in applying an impulse to the water is increased in real-time. By use of impulse propulsion, movement of a vessel utilizing impulse propulsion may be carried out with the propeller operating intermittently at high rotational speed preferably with a dwell period in-between, during which the propeller is non-rotating or rotating at a substantial lower RPM.

“Vessel” as used herein refers to a maritime vessel equipped with one or more propulsion devices with propellers for providing a trust to propel the vessel. A vessel may be a sub-merged vessel, such as a submarine, a displacement (floating) vessel, a planning vessel and/or a vessel comprising one or more hydrofoils.

“RPM” and “rotational speed of the propeller” are used interchangeably herein.

Impulse propulsion with dwell periods has potential to substantially decrease the power consumption of a propulsion device.

“in real-time” as used herein e.g. in connection with “increase or decrease in real-time the rotational speed of said propeller” preferably refers to that the increase or decrease is carried out as fast as feasible by the electrical motor and propulsion device. In some embodiments utilizing a permanent magnet rim driven thruster, real-time is provided by the thruster's ability to provide a rapid increase in and a high value of the force acting on the rim and thereby on the propeller blades.

“Dwell time” preferably refers to a time period during which the rotational speed is below 20%, preferably below 15%, such as below 10% of the maximal rotational speed of the propeller. In some embodiments, the rotational speed during a dwell time is essentially zero, e.g. where the propeller is in an idle state. In other embodiments the rotational speed of the propeller is zero.

By operating the propeller with an increase and a decrease of RPM, preferably including a dwell time after the decrease, a ring vortex may be generated downstream of the propeller during an increase of RPM. Such a ring vortex is generated as the water downstream and outside propeller has a lower velocity than the water flowing out from the propeller whereby a shear layer is generated which roll-up in a ring vortex. The ring vortex is typically initiated at an outer downstream (relatively to the propeller and flow) edge of a casing surrounding the propeller and the vortex moves downstream (relatively to a forward movement of the propeller) together with the flow of water. Generation of a ring vortex is particular pronounced in rim drive azimuth thrusters and in rim drive tunnel thrusters or the like. Without being bound by theory, the inventor has surprisingly found that formation of a ring vortex increases the efficiency of the use of a propulsion device. Such an increase in efficiency may seem counter intuitive as a vortex in general may be considered as energy consuming. However, in regards to impulse propulsion, the presence of a ring vortex is suggested to enhance the propeller's capabilities of applying impulse to the water, possibly due to the ring vortex provides a backpressure or flow resistance in the water immediately downstream of the propeller. Such a backpressure of flow resistance dies out over time as the vortex moves far downstream the propeller. However, in impulse propulsion, where the RPM is repeatedly increased and decreased, ring vortices are generated in the vicinity of the propeller, whereby the effect of the backpressure or flow resistance can be exploited in a positive manner with respect to efficiency. The inventor has further hypothesised, that during an alternating increase and decrease of the rotational speed there will be a velocity drop due to the periodic vorticity on the pressure side of the thruster with the consequence that the local pressure at the pressure side (downstream) will increase. This will cause the total thrust to increase, and given a constant power to the propeller, the efficiency is believed to increase

In a one aspect, the invention relates to a computer program product being adapted to enable a computer system comprising at least one computer having data storage means in connection therewith to control a propulsion system as disclosed herein, such as a computer program product comprising instructions which, when the program is executed by a computer, cause the computer to carry out the method according to the first aspect of the invention. In some embodiments, the computer program is a thruster allocation routine. Such a thruster allocation routine may be configured to carry out a dynamic positioning and/or low speed manoeuvring of the vessel during which the routing is allocating thrust vectors (direction and magnitude) such that these forces are counteracting the environmental forces. A thruster allocation routine typically receives positioning input based on GPS, motion sensors and/or gyrocompasses. In addition wind forces may be included as input to the thruster allocation routing.

### BRIEF DESCRIPTION OF THE FIGURES

The present invention and in particular preferred embodiments thereof will now be described in more details with regard to the accompanying figures. The figures show ways of implementing the present invention and are not to be construed as being limiting to other possible embodiments falling within the scope of the attached claim set.

FIG. 1 schematically illustrates a method of providing impulse propulsion to a vessel in a first embodiment of the invention;

FIG. 2 schematically illustrates timewise evolution of a force (right-hand side of FIG. 2) acting on the rim of a permanent magnet rim driven propeller (left-hand side of FIG. 2) during impulse propulsion in a preferred embodiment of the invention. Included in the graph in the right-hand side of FIG. 2 is a prior art propulsion scheme.

FIG. 3 illustrates thruster responses produced by a method according to a preferred embodiment of the invention, the results illustrated are provided by a computational fluid dynamic model.

FIG. 4A and FIG. 4B illustrates timewise thrust responses during an increase of rotational speed produced by a method according to a preferred embodiment of the invention, the results illustrated are provided by a computational fluid dynamic model.

### DETAILED DESCRIPTION OF PREFERRED EMBODIMENTS

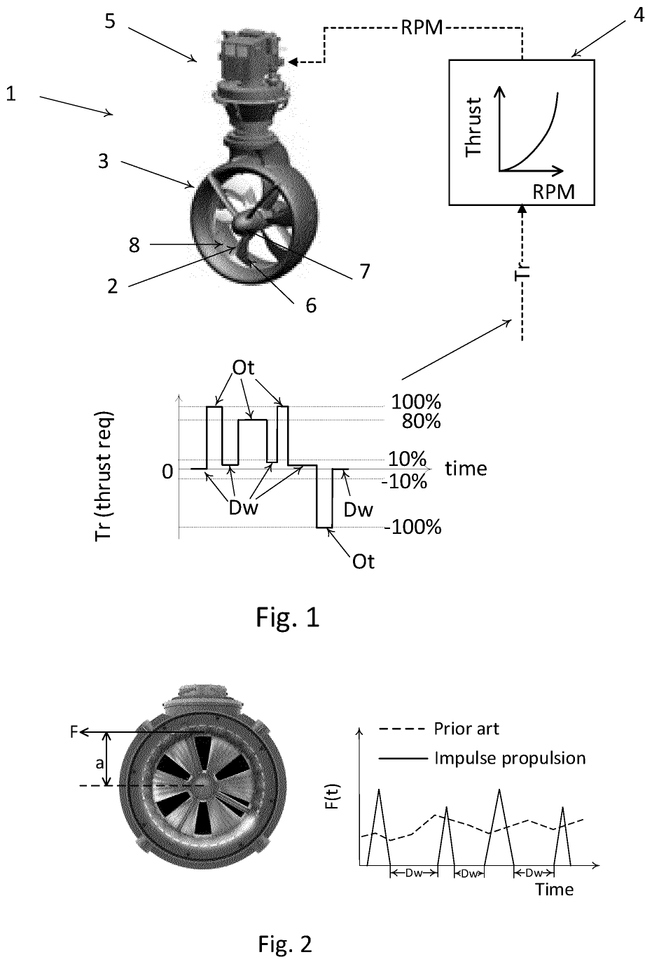

With reference to FIG. 1, a preferred embodiment of a method of providing impulse propulsion to a vessel by a propulsion system 1 will be detailed.

As illustrated in FIG. 1, a propulsion system 1 according to a first preferred embodiment comprises a propulsion device 1. The propulsion device 1 may vary from the propulsion device illustrated in FIG. 1, although a propulsion device 1 should have a rotatable propeller 2, as the rotatable propeller 2 is responsible for producing hydrodynamic forces by rotation. However, as the rotatable propeller 2 co-operates with the geometry surrounding the propeller, the propulsion device 1 is said to produce a thrust upon rotation of the propeller 2.

The magnitude of the thrust produced by the propulsion device depends inter alia on the rotational speed of the propeller 2. A schematic example on one such dependency is illustrated in FIG. 1 inside the schematically illustrated control unit 4. As illustrated, the thrust produced depends on the rotational speed, RPM, which dependency can in some cases be approximated by Thrust≈constant·RPM³. Such a dependency is also referred to as a thrust curve. However, the invention is not limited to such a dependency.

An electrical motor 3 is provided and coupled to the propeller 2 to provide the rotational speed of the propeller. In the embodiment of FIG. 1, where the propulsion device is a permanent magnet rim driven thruster, also known as a rim drive azimuth thruster (RD-AZ), the electrical motor is provided inter alia by magnets arranged on a rim to which the tip of the propeller blades are connected and a by number of coils arranged in a stationary part of the thruster in such a manner that a supply of electrical power to the coils provides a rotation of the rim and thereby the propeller blades.

Although the detailed description of preferred embodiments is made with reference to a rim drive azimuth thruster, other propulsion devices, such as a rim drive tunnel thruster (RD-TT), can be used.

A control unit 4 is provided, and the control unit 4 may be what is commonly referred to as a propulsion control system. The control unit 4 is configured to receive a thrust request Tr representing a thrust to be requested from the propulsion device. Within the meaning of a thrust to be requested is that although the thrust curve provides a one-to-one correspondence between thrust and RPM, the actual conditions at which the thruster operates may deviate from the conditions at which the thrust curve are obtained, meaning that the actual thrust produced by the thruster may deviate from what is stated by the thrust curve.

With a trust request Tr received by the control unit 4, the control unit 4 determines based on the thrust curve an RPM for the for the propeller based on the thrust curve. While the RPM for the propeller 2 and the RPM for the electrical motor is the same for a RD-AZ, this may not be the case for other propulsion device where rotation of the propeller involves transferring a rotational of the electrical motor to the propeller via a geared connection having a gearing deviating from 1:1. However, in such cases, there is a one-to-one relation between the rotation of the electrical motor and the rotation of the propeller allowing for rotating the electrical motor with a rotational speed providing a rotation of the of propeller in accordance with the thrust curve.

It is noted that the invention is not limited to the use of a thrust curve as other relationships between RPM and rotational speed are available.

Based on the thrust request Tr, the corresponding rotational speed of the propeller is determined by the control unit 4, which control unit 4 is further configured to control the electrical motor 3 to rotate said propeller 2 at a rotational speed at corresponding to the thrust request, Tr.

In a preferred embodiment, the method comprises steps for increasing or decreasing the rotational speed of the propeller, and such steps preferably comprises the following.

The control unit receives a thrust request Tr, and upon receipt of the thrust request Tr, the control unit 4 controls the electrical motor 3 to increase or decrease in real-time the rotational speed of the propeller 2 to a rotational speed corresponding to the thrust request (Tr). The situation of increasing the rotational speed occurs when the actual rotational speed of the propeller is lower than what corresponds the thrust request, and the decreasing occurs when the actual rotational speed of the propeller is higher than what corresponds to the thrust request. Thus, in preferred embodiments, the control unit 4 maintains a record of the actual rotational speed of the propeller to determine whether an increase or decrease in rotational speed is to be carried out.

The increase and decrease are carried out in real-time, which preferably refers to that essentially no time delay is introduced during the increase and decrease. The rate at which the rotational speed is increased and decreased (dRPM/dt) is typically determined by the propulsion system's ability to respond to a change. In a RD-AZ the force F (see FIG. 2) and the moment F·a (see FIG. 2) acting on the propeller is high already at zero RPM which allow for a fast response by the propeller upon supplying electrical power to the electrical motor.

Such a fast response provides that a high momentum can be applied onto the fluid fast, as the rotational speed of the propeller may be increased fast.

While it may beneficial from a power consumption perspective to control the rotational speed between the two extremities being max RPM and zero RPM, preferred embodiments of the invention is implemented by operating the RPM so that it is within the limits of
Thrust larger than 60% such as larger than 80% of max RPM
   or
Thrust smaller than 20% such as smaller than 10% of max RPM

That is, the thrust request Tr for the increase corresponds to at least than 60% such as at least 80% of a maximal rotational speed of the propeller. And, the thrust request for the decrease corresponds to at the most 20% such as at the most 10% of said maximal rotational speed of the propeller. In some embodiments, the RPM is reduced to essentially zero RPM, such as zero RPM. Essentially zero RPM may refer to a situation where the propeller is in an idle state where a flow of water may induce some rotation of the propeller. In some embodiments, the thrust request comes from a thrust allocation routine.

FIG. 1 also illustrates in the lower part of FIG. 1, a preferred embodiment in which the rotational speed corresponding to the thrust request for the increase is maintained during an operation time Ot. After the operation time has ended, the rotational speed is decreased to the rotational speed corresponding to the thrust request for the decrease. As illustrated, the operation time Ot has different durations, although the invention is not limited to such different durations. During the operation time Ot, the rotational speed is typically constant, but may vary.

Preferred embodiments of impulse propulsion according to the invention may involve a stepwise increase or decrease of rotational speed. According, a first thrust request for increase rotational speed up till e.g. 50% of maximal rotational speed may be followed by a second thrust request for increase rotational speed up till e.g. 80% of maximal rotational speed. Similar the a thrust request for decrease may be to reduce to e.g. 40% of maximal rotational speed followed by a thrust request to reduce to 10% of maximal rotational speed. Thus, increase and/or decrease may be carried out step-wise. Operation times may be included in between changing rotational speed.

It has also been found beneficial for the power consumption that a dwell time Dw follows after the decrease has been carried out. However, while the duration of the dwell time in some cases has a longer duration, a dwell time may not extend over a time period longer than the time it take set-up the propulsion device to initiate an increase, which essentially means an increase may follow immediately after a decrease in rotational speed.

As indicated in FIG. 1, the rotational speed of the propeller may be constant during the dwell time. However, the rotational speed of may be increased and/or decreased or be a combination of constant, increased and/or decreased.

In the embodiment illustrated in FIG. 1 the rotational speed during the dwell time Dt is below 10% and in some instances 0. In other embodiments, the said rotational speed of propeller is below 20%, preferably 15%, such as below 10% of the maximal rotational speed of the propeller during the dwell time Dt.

In preferred embodiments, the rotational speed of the propeller is essentially zero, or zero during the dwell time. Here, “essentially zero” typically refers to a situation in which the propeller is idle state.

In a preferred use case, the method comprising providing a number of succeeding alternating thrust requests, that is typically a number of thrust requests as exemplified here:
. . . Tr_{inc}, Tr_{dec}, Tr_{inc}, Tr_{dec}, Tr_{inc}, Tr_{dec}, Tr_{inc}, Tr_{dec} . . .

Here Tr_{inc} is a thrust request to increase rotational speed and Tr_{dec} is a thrust request to decrease rotational speed. Tr may be stepwise as disclosed above. A combination of Tr_{inc}, Tr_{dec} is considered to represent an alternating thrust request.

In preferred embodiments involving such alternating thrust request, at least for a number, such as two, three, four, five, or even a higher number, of the alternating thrust requests, the thrust requests for said increases have different magnitudes. As an example, in the embodiment illustrated in FIG. 1 the thrust request for increase of first alternating thrust request corresponds to a rotational speed with a magnitude of 100%, thrust request for decrease of the second alternating thrust request has a magnitude of 80%, the third has a magnitude of 100% and the fourth has a magnitude of-100%.

In preferred embodiments, at least for a number, such as two, three, four, five, or even a higher number, of the alternating thrust requests, the thrust requests for increase have same magnitude. This may be a thrust request correspond to a rotational speed with a magnitude of 10%.

In other embodiments, at least for a number, such as two, three, four, five, or even a higher number, of the alternating thrust requests, the thrust requests for the decrease have different magnitudes. One such example is illustrated in FIG. 1, where the thrust request for decrease of the first alternating thrust request corresponds to a rotational speed with a magnitude of 5%, the thrust request for decrease of the second alternating thrust request for decrease has a magnitude of 8%, the third has a magnitude of 3% and the fourth has a magnitude of 0%.

In some preferred embodiments, at least for a number, such as two, three, four, five, or even a higher number, of the alternating thrust requests, the thrust requests for the increase may have same magnitude.

As also illustrated in FIG. 1, the rotational speed may be kept constant after having reached the rotational speed corresponding to a thrust request. In preferred embodiment, such a operation time is utilized in combination with the number of alternating thrust request, by at least for a number, such as two, three, four, five, or even a higher number, of the alternating thrust requests, the rotational speed corresponding to the thrust request for the increase is maintained during an operation time Ot, whereafter the rotational speed is decreased to the rotational speed corresponding to the thrust request for the decrease.

In preferred embodiments, at least for a number, such as two, three, four, five, or even a higher number, of the alternating thrust requests, the duration of the operation times Ot have different magnitudes. One such example is illustrated in FIG. 1, from which it appears that the operation times Ot are different from each other.

In preferred embodiments, at least for a number, such as two, three, four, five, or even a higher number, of the alternating thrust requests, the alternating thrust requests are timewise spaced by the dwell time. In preferred embodiments, at least some the dwell times have different durations. In the example illustrated in FIG. 1 the dwell times are all different from each other, however the invention is not limited to such differences.

FIG. 2 right-hand side, conceptually illustrates how preferred embodiments of the invention may be less power consuming than prior art methods. The thruster illustrated in FIG. 2 is a rim drive tunnel thruster, although the invention is not limited to such thruster. In the embodiment shown in FIG. 2, the aim is station keeping of the vessel. In the prior art method, this is carried out by operating the propeller constantly although the force F(t) in FIG. 2 applied to rotates the propeller varies over time as illustrated by the dotted line.

In right-hand side of FIG. 2, the timewise evolution of the force F(t) according to a preferred embodiment is also plotted and labelled “Impulse propulsion”.

Assuming an idealized, loss-less fluid dynamic model, the amount of impulse supplied onto the seawater by the propulsion device may be expressed by

I=∫F(t) dt

Or, expressed in discrete form:

$$F ( t ) = \frac{\partial I}{\partial t} \approx \frac{Δ I}{Δ t}$$

Thus, by increasing F(t) fast, a larger change in impulse onto the seawater is achieved relatively to a slower increase in F(t). This may in a non-limiting manner be symbolic written as:

$$\frac{\partial F ( t )}{\partial t}$$

should occur real-time either from low RPM (preferably less than 10% max RPM) to high RPM (preferably larger than 80% max RPM) or vice versa.

It is noted that propellers typically may rotate in a forward rotation and in a reversed rotation. In preferred embodiments, the RPM is accordingly not given any rotational direction. A thrust produced may be less in reverse rotation as the blades are designed hydro dynamically for one rotational direction. For rim drive azimuth thrusters, the azimuth function can be used to prevent reverse rotation, and for rim drive tunnel thrusters one may assume that maximum RPM and thrust can be provided for both rotational directions due to design.

In FIG. 2, right-hand side, F(t) is plotted for clarification purposed to vary between zero and a higher value. As the energy consumption of the propulsion device is proportional to the area under the dotted line, it is clear from a visual inspection that the impulse propulsion has a lower energy consumption than the prior art.

As illustrated in FIG. 2, preferred embodiments of impulse propulsion comprises that the propulsion device is operated intermittently wherein the thrust request Tr for the increase of RPM is followed by the thrust request for the decrease of RPM. That is, in preferred embodiments the RPM decreases immediately after the RPM has been increased. Impulse propulsion may include a dwell time, as illustrated in FIG. 2.

As preferred embodiments of the invention resides in a fast increase of RPM, it may be preferred that the electrical motor and the propeller are mutually configured to provide a maximum rotational force to said propeller 2 upon supplying the electrical motor with electrical power. Such a mutual configuration is prominent in embodiments involving rim drive, such as RD-AZ or RD-TT, where the configuration of magnet and coils provides a large force on the rim even at zero RPM.

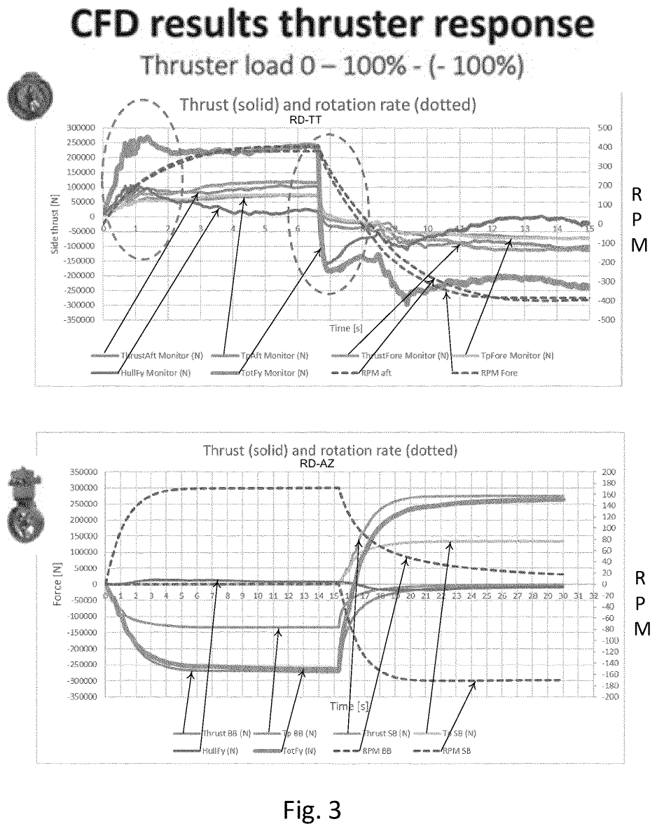

Impulse propulsion may also comprise a period in time where the rotational speed after being increased or decreased in real-time is maintained substantial constant. Examples on this are illustrated in FIG. 3 where RPM after a change is maintained at substantial constant value before changes are made to the RPM. FIG. 3 also shows that the RPM may be smaller than zero which refers to that the propeller may rotate both in clock-wise and counter clockwise direction. While maintaining a substantial constant RPM after increase or decrease of the RPM may result in that the impulse propulsion enters into what may be referred to as conventional propulsion, the positive effect of the impulse propulsion may still be obtained during the increase of RPM. The upper part of FIG. 3 is for rim drive tunnel thrusters and lower part is for rim drive azimuth thrusters.

In FIG. 3, the following abbreviations are used:
“ThrustAft” for thrust aft,
“Tp” for propeller thrust; “TpAft” for propeller thrust aft; “TpFore” for propeller thrust fore, “Tp BB(N)” for propeller thrust port (Newton), “Tp SB(N) for propeller thrust starboard (Newton);
“ThrustFore Monitor (N)” for thrust fore monitor (Newton)
“Thrust BB(N)” for Thrust port side (Newton);
“Thrust SB(N)” for Thrust starboard side (Newton),
“HullFY” for hull thrust; HullFy (N)” for hull thrust (Newton),
“TotFY” for total sideways thrust (Tp+HullFY),
“RPM aft” for rotational speed aft;
“RPM Fore” for rotational speed fore;
“RPM BB” for rotational speed port side,
“RPM SB” for rotational speed starboard side,
“Monitor” is a data term referring to that the values are calculated and shown.

The ellipses drawn by broken lines indicate regions where total sideways thrust (TotFY) changes rapidly. Tunnel thrusters generates a thrust from the propeller, which generates a pressure field on the hull where the sum of the integrated forces (resulting forces) provides a force in the same direction as the propeller thrust. Typically, the relation between the Tp/TotFY is about 70/30.

The upper part of FIG. 3 is obtained by two tunnel thrusters (RD-TT) one fore and one aft. The lower part of FIG. 3 is obtained by two azimuth thrusters (RD-AZ) one starboard and one port, both aft.

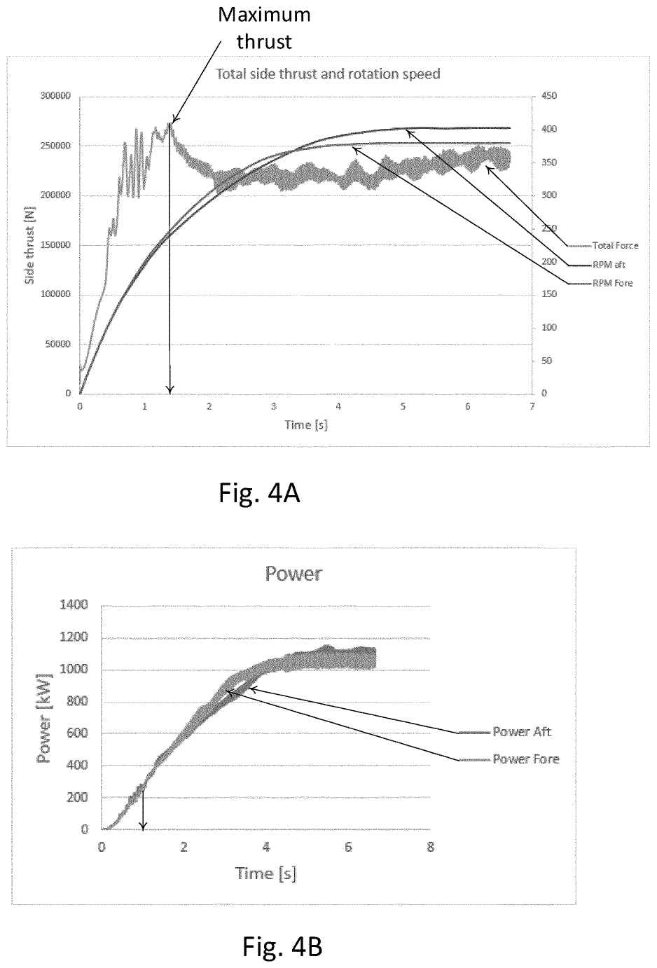

FIGS. 4A and B illustrates an example of an increase of RPM in real-time. The results are provided by a computational fluid dynamic model, and thrusters are two tunnel thrusters (rim drive tunnel thrusters) placed in the forebody of the vessel. FIG. 4A, shows the total thrust acting on the hull when the thrusters are “boosted”, that is provides maximum thrust response. The timewise evolution of the RPM for the two thrusters is also shown in FIG. 4A. Kindly observe that in FIGS. 4A and 4B “fore” refers to the foremost thruster and “aft” refers to the thruster located behind the foremost thruster in a direction towards stern.

FIG. 4B illustrates power consumption during the same time as for FIG. 4A.

From FIG. 4A it is seen that the maximum thrust is achieved at time being slightly larger than 1 seconds (approximately 1.33 seconds). From FIG. 4B it is seen that the maximum thrust requires approximately 200 kW. This appears to be in stark contrast to a substantially steady state which is achieved after about 2 seconds (see FIG. 4A-total force) and at which the power consumption is approximately 1100 kW and even produces a lower thrust than maximum thrust.

In terms of the present invention, at least the part of the FIG. 4A until maximum thrust is achieved can be considered to be an example on impulse propulsion.

Thus, the thrust/power consumption relation power is power consumption wise more favourable than steady state.

Although a propulsion device may be virtually any kind of device comprising a propeller, preferred embodiments of the invention utilizes a thruster, such as an azimuth thruster and/or a tunnel thruster. In preferred embodiment, the thruster may be rim drive azimuth thruster and/or a rim drive tunnel thruster. Such a thruster may typically have propeller blades connected at their tips to a rim whereby there is no gap between the tip of the blades and the rim. Such zero-gap configuration provides a higher hydrodynamic efficiency of the propeller as essentially no tip vortices are generated compared to an open propeller configuration. Such tip vortices otherwise originate from a flow of water from the high pressure side to the low pressure side of the propeller blade, and such passage of water is prevented due to the zero-gap.

While a tunnel thruster is useable in general as a thruster in general, preferred embodiments of the invention use a tunnel thruster to provide essential lateral thrust only, such as used as a bow thruster.

In preferred embodiments where a thruster is used, the thruster may be a permanent magnet rim driven thruster. In such a thruster, permanent magnets are arranged on a rim 8 from which propeller blades 6 of the propeller 2 extends towards a hub 7 of the thruster. One such example is illustrated in FIG. 1 which illustrates an azimuth thruster. Due to the integration of the propeller blades 6 in the thruster, no gaps are present between tips of the propeller blades 6 and the rim 8, and no gaps are present between roots of the propeller blades 6 and the hub 7. Accordingly, the thruster is a zero-gap configuration.

Alternatively to a rim driven thruster, preferred embodiments utilizes a shrouded propeller. Such a shrouded propeller can also be considered to a zero-gap configuration and the propeller is typically driven by a central axle connected to an electrical motor.

As the motor providing the rotational speed of the propeller is electrical, the motor is to be supplied with electrical power. Several options are available for supply of electrical power, and in some preferred embodiments, electrical power supplied to the electrical motor 3 for rotation of said propeller 2 is at least partly, such as fully, provided by an electrical energy storage such as one or more batteries. Thus, in some embodiments all of the electrical power is provided by the electrical storage and in other embodiments the electrical storage is an add-on supply of electrical power to another source of electrical power.

Another source of electrical power, which may be a stand-alone source, may be a combustion-electric drive chain, such as a Diesel-electric drive chain or an Otto-electrical drive chain. In such embodiments, the combustion engine is driving a generator which generates electrical power. In embodiments comprising a combustion-electric drive chain, the drive chain may comprise an electrical energy storage, such as a battery, where the electrical energy storage is electrically charged by generator driven by a combustion engine of the drive chain, and the electrical power supplied to said electrical motor is supplied at least partly, such as fully by said energy storage. A configuration of a combustion-electric drive chain with energy storage may have the advantage in connection with impulse propulsion that the combustion engine can be rated to provide less effect than what is need to drive the propeller at maximum RPM. This is due to that combustion engine charges the electrical storage when RPM is low, and the electrical storage is discharged at high RPM.

In preferred embodiments, the electrical motor 3 is an AC motor and the electrical power supplied to the electrical motor for rotation of said propeller 2 is supplied through a frequency converter. Such a frequency converter is configured to supply an alternating current at a controllable frequency. In such embodiments, the frequency of the alternating current controls the rotational speed of electrical motor 3. Thus, by controlling the frequency of the alternating current, control of the rotational speed of the propeller is provided. Accordingly, in preferred embodiments, a thrust request Tr is transformed into rotational speed of the propeller (as detailed in regards to FIG. 4) and this rotational speed is then transformed into a frequency to be delivered by the frequency controller.

In preferred embodiments, the frequency converter is configured to provide the increase or decrease of RPM in real-time by being configured to ramp-up and ramp-down the frequency of the alternating current. The ramp-up or ramp-down may preferably be carried out with a rate of change (dHz/dt) larger than 10 Hz per seconds, such as larger than 20 Hz per second and smaller than 30 Hz per seconds.

In addition, the rate of change (dHz/dt) may not need to be constant during a ramp-up or ramp-down, as it may be advantageous to vary the rate of change, that is d² Hz/dt² being different from zero. For instance, selecting d² Hz/dt² to be increasing over time during increase of RPM and decreasing over time during decrease RPM may be advantageous in regards to accelerating and decelerating the rotating propeller as the propeller has a substantial moment of inertia.

One highly advantageous effect of application of impulse propulsion is provided in dynamical positioning of a vessel, during which the vessel is requested to maintain its position, such as maintaining a position prescribed by co-ordinates, e.g. GPS coordinates. In such embodiments, a vessel typically comprises at least two propulsion devices 1 as otherwise disclosed herein.

In preferred embodiments, the propulsion devices may be two azimuth thrusters at an aft of the vessel and one or more tunnel thrusters in a bow of the vessel. Each of these propulsion devices 1 are configured to provide impulse propulsion by a method according a preferred embodiment disclosed herein.

Preferred embodiments of dynamical position of a vessel make use of a thruster allocation routine which provides the thrust requests Tr's to the control units 4, so as to maintain the vessel in a substantial fixed position. Such a thrust allocation routine is computer implemented and an input to the routine is an actual GPS location provided by a GPS system. The thrust allocation routine calculates what may be referred to a position correction based on the actual GPS location and the prescribed GPS location and translates the position correction into thrust requests to the propulsion devices.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

### LIST OF REFERENCE SYMBOLS USED

1 Propulsion system
2 Rotatable propeller
3 Electrical motor
4 Control unit
5 Power supply unit (of propulsion system)
6 Propeller blade
7 Hub
Tr Thrust request
Dw Dwell time
Ot Operation time

1. A method of providing impulse propulsion to a vessel by a propulsion system, said propulsion system comprising
a propulsion device having a rotatable propeller and producing a thrust having a magnitude depending on a rotational speed of said propeller;
an electrical motor coupled to said propeller to provide said rotational speed,
a control unit, such as an propulsion control system, configured to receive a thrust request representing a thrust to be requested from the propulsion device and configured to control said electrical motor to rotate said propeller at a rotational speed at corresponding to the thrust request,
the method comprising
upon receipt of a thrust request by said control unit, said control unit controls said electrical motor to increase or decrease in real-time the rotational speed of said propeller to a rotational speed corresponding to the thrust request.

2. A method according claim 1 wherein
said thrust request for said increase corresponds to at least 50% such as at least 60%, such as at least 80% of a maximal rotational speed of the propeller, and/or
said thrust request for said decrease corresponds to at the most 20%, such as at the most 10% of said maximal rotational speed of the propeller or said decrease corresponds to an rotational speed being essentially zero, such as zero.

3. A method according to claim 1, wherein the rotational speed corresponding to said thrust request for said increase is maintained during an operation time, whereafter said rotational speed is decreased to the rotational speed corresponding to said thrust request for said decrease.

4. A method according to claim 1, wherein said propulsion device is operated intermittently wherein said thrust request for said increase is followed by said thrust request for said decrease.

5. A method according to claim 1, wherein a dwell time follows after said decrease has been carried out.

6. A method according to claim 5, wherein during said dwell time the rotational speed of said propeller is constant, increased and/or decreased.

7. A method according claim 5, wherein during said dwell time said rotational speed of said propeller is below 20%, preferably 15%, such as below 10% of the maximal rotational speed of the propeller.

8. A method according to claim 5, wherein during said dwell time rotational speed of said propeller is essentially zero, or zero.

9. A method according to claim 1, comprising a number of succeeding alternating thrust requests each comprising said thrust request for said increase followed by said thrust request for said decrease, wherein at least for a number, such as two, three, four, five, or even a higher number, of said alternating thrust requests, the thrust requests for said increases have different magnitudes.

10. A method according to claim 9, wherein at least for a number, such as two, three, four, five, or even a higher number, of said alternating thrust requests, the thrust requests for said increase have same magnitude.

11. A method according to claim 9, wherein at least for a number, such as two, three, four, five, or even a higher number, of said alternating thrust requests, the thrust requests for said decrease have different magnitudes.

12. A method according to claim 9, wherein at least for a number, such as two, three, four, five, or even a higher number, of said alternating thrust requests, the thrust requests for said increase have same magnitude.

13. A method according to claim 9, wherein at least for a number, such as two, three, four, five, or even a higher number, of said alternating thrust requests, the rotational speed corresponding to said thrust request for said increase is maintained during an operation time, whereafter said rotational speed is decreased to the rotational speed corresponding to said thrust request for said decrease.

14. A method according to claim 13, wherein at least for a number, such as two, three, four, five, or even a higher number, of said alternating thrust requests, the duration of said operation times have different magnitudes.

15. A method according to claim 9, wherein said propulsion device is operated intermittently wherein said thrust request for said increase is followed by said thrust request for said decrease, and further wherein at least for a number, such as two, three, four, five, or even a higher number, of said alternating thrust requests, said alternating thrust requests are timewise spaced by said dwell time, preferably at least some said dwell times have different durations.

16. A method according to claim 1, wherein said electrical motor and said propeller are mutually configured to provide a maximum rotational force to said propeller upon supplying said electrical motor with electrical power.

17. A method according to claim 1, wherein said rotational speed after being increased or decreased in real-time is maintained substantial constant.

18. A method according to claim 1, wherein said propulsion device is a thruster, such as an azimuth thruster and/or a tunnel thruster.

19. A method according to claim 18, wherein said thruster is a permanent magnet rim driven thruster, wherein magnets are arranged on a rim from which propeller blades of said propeller extends towards a hub of said thruster with no gaps between tips of said propeller blades and said rim, and with no gaps between roots of said propeller blades and said hub.

20. A method according to claim 1, wherein said propulsion device is a shrouded, ducted propeller or nozzle propeller.

21. A method according to claim 1, wherein electrical power supplied to said electrical motor for rotation of said propeller is at least partly, such as fully, provided by an electrical energy storage such as one or more batteries.

22. A method according to claim 1, wherein electrical power supplied to said electrical motor for rotation of said propeller is at least partly, such as fully, provided by a combustion-electric drive chain, such as a Diesel-electric drive chain or an Otto-electrical drive chain, wherein said drive chain comprising an electrical energy storage, such as a battery, said electrical energy storage is electrically charged by a generator driven by a combustion engine of said drive chain, and said electrical power supplied to said electrical motor is supplied at least partly, such as fully by said energy storage.

23. A method according to claim 1, wherein said electrical motor is an AC motor and wherein electrical power supplied to said electrical motor for rotation of said propeller is supplied through a frequency converter supplying an alternating current, and wherein a frequency of said alternating current controls the rotational speed of said electrical motor and thereby said rotational speed of said propeller.

24. A method according to claim 23, wherein said frequency converter is configured to provide said increase or decrease in real-time by being configured to ramp-up and ramp-down said frequency of the alternating current preferably with a rate of change (dHz/dt) larger than 10 Hz per seconds, such as larger than 20 Hz per second and smaller than 30 Hz per seconds.

25. A method of dynamical positioning of a vessel, said vessel comprising at least two propulsion devices, such as two azimuth thrusters at an aft of the vessel and one or more tunnel thrusters in a bow of the vessel, wherein said propulsion devices each are configured to provide impulse propulsion by a method according to claim 1, and wherein a thruster allocation routine provides said thrust requests to said control units, so as to maintain the vessel in a substantial fixed position.

26. A propulsion system for providing impulse propulsion to a vessel by a propulsion system, said propulsion system comprising
a propulsion device having a rotatable propeller and producing a thrust having a magnitude depending on a rotational speed of said propeller;
an electrical motor coupled to said propeller to provide said rotational speed,
a control unit, such as an propulsion control system, configured to receive a thrust request representing a thrust to be requested from the propulsion device and configured to control said electrical motor to rotate said propeller at a rotational speed at corresponding to the thrust request,
said propulsion system being configured to
upon receipt of a thrust request (Tr) by said control unit, said control unit controls said electrical motor to increase or decrease in real-time the rotational speed of said propeller to a rotational speed corresponding to the thrust request.

27. (canceled)
